(19) United States
(12) Patent Application Publication
(10) Pub. No.: US 2011/0086279 A1
(43) Pub. Date: Apr. 14, 2011

(54) FLUID COOLING APPARATUS FOR A FUEL CELL DEVICE AND FUEL CELL SYSTEM

(75) Inventors: Andreas Brinner, Rutesheim (DE); Tilo Maag, Pfinztal (DE)

(73) Assignee: Deutsches Zentrum fuer Luft-und Raumfahrt e.V.

(21) Appl. No.: 12/902,672

(22) Filed: Oct. 12, 2010

Related U.S. Application Data
(63) Continuation of application No. PCT/EP2009/053959, filed on Apr. 2, 2009.

(30) Foreign Application Priority Data
Apr. 18, 2008 (DE) 10 2008 020 903.1

(51) Int. Cl. H01M 8/04; H01M 8/06

(52) U.S. Cl. 429/419; 429/437

(57) ABSTRACT

Liquid cooling apparatus for a fuel cell device, which is configured as an independent unit and by means of which the fuel cell device can be provided with cooling liquid and heated liquid can be removed from the fuel cell device, comprising an inlet connection for liquid, an outlet connection for liquid, a radiator, at least one fan, which is speed-controlled and directed at the radiator, and a temperature-controlled two-way valve, wherein a first path passes through the radiator and a second path by-passes the radiator and a mass flow distribution of the liquid into the first path and the second path can be adjusted by the two-way valve.

### CROSS-REFERENCE TO RELATED APPLICATIONS

This application is a continuation of international application number PCT/EP2009/053959 filed on Apr. 2, 2009. The present disclosure claims priority to and the benefit of International Patent Application Number PCT/EP2009/053959, filed Apr. 2, 2009, and German Patent Application Number 10 2008 020 903.1, filed Apr. 18, 2008, both of which are incorporated herein by reference in their entirety and for all purposes.

### BACKGROUND OF THE INVENTION

The invention relates to a liquid cooling apparatus for a fuel cell device, which is configured as an independent unit, and by means of which the fuel cell device can be provided with cooling liquid and heated liquid can be removed from the fuel cell device.

The invention furthermore relates to a fuel cell system.

A fuel cell system is known from WO 2006/032359, which comprises a fuel cell device with one or more fuel cell blocks, in which chemical energy can be converted into electrical energy, an oxidator supply device for the fuel cell device, a fuel supply device for the fuel cell device and a control device. The corresponding devices may be configured as modules. It is described that a cooling device can also be configured as a module.

A fuel cell system is known from DE 101 27 599 A1, which comprises an auxiliary energy source, which provides the auxiliary energy to start up the fuel cell system.

A fuel cell system is known from DE 101 27 600 A1, which has an adjustment apparatus, by means of which supply parameters of a fuel and oxidator to a fuel cell block can be rigidly predetermined.

A fuel cell system is known from DE 11 2005 003 074 T5, which has a coolant circulation system for circulating a coolant from a fuel cell to the fuel cell, the coolant circulation system having a flow control means to prevent the coolant, which has a predetermined temperature difference from the fuel cell, from flowing into the fuel cell.

An apparatus for cooling a fuel cell is known from DE 11 2005 000 265 T5, which adjusts a temperature of the fuel cell to a desired value adjustment temperature by supplying a coolant, in which a parameter based on a temperature of the coolant can be controlled to keep an electric conductivity at the desired value adjustment temperature within an electric desired value conductivity range, specifically based on the correlation between the parameter, which relates to the coolant temperature, and the electrical conductivity of the coolant.

A method for determining a temperature of a coolant in a coolant circulation system is known from DE 10 2005 045 557 B4, in which a coolant through-flow valve is provided in the coolant circulation system, wherein the coolant through-flow valve comprises a valve housing and an expansion element, which is provided in the valve housing, in order to control a through-flow of the coolant through the valve housing, an ohmic resistance of the expansion element is measured, and the ohmic resistance of the expansion element is correlated with the temperature of the coolant.

A cooling system for a fuel cell is known from DE 11 2004 001 059 T5, which has a cooling apparatus, which controls the temperature of the fuel cell in that a cooling liquid is fed by means of a pump to the fuel cell, has a contamination removal apparatus, which is provided in a cooling liquid line for the cooling liquid, which removes contamination in the cooling liquid, and has a flow production device for causing the cooling liquid within the cooling liquid line to flow through the contamination removal apparatus, when the fuel cell is not working.

A method for actuating a fuel cell system is known from US 2007/0166577 A1, in which, in a first step, a fuel cell is actuated in a low temperature actuation mode and is heated up in the process if a low temperature actuation condition is satisfied when the fuel cell is started, and in which, in a second step, a membrane electrode unit of the fuel cell is dried, if the power production capacity of the fuel cell is lower than a predetermined capacity.

### SUMMARY OF THE INVENTION

In accordance with the present invention, a liquid cooling apparatus for a fuel cell device is provided, which can be used universally.

In accordance with an embodiment of the invention, an inlet connection for liquid is provided, an outlet connection for liquid is provided, a radiator is provided, at least one fan is provided, which is speed-controlled and which is directed at the radiator, and a temperature-controlled two-way valve is provided, a first path passing through the radiator and a second path bypassing the radiator and a mass flow distribution of the liquid into the first path and the second path being adjustable by means of the two-way valve.

In a simple and favourable system structure, cooling liquid for a fuel cell device can be provided and guided through the fuel cell device in a circuit by means of the liquid cooling device according to the invention. Owing to the configuration as an independent unit, the liquid cooling apparatus according to the invention can be used universally. It can be coupled to a fuel cell device.

The cooling can be controlled by means of the (internal) two-way valve and the at least one fan. A simple adaptation to different operating temperature levels of the fuel cell device can be carried out, for example, by means of preselection of the control temperature of the two-way valve.

The temperature control of the two-way valve can be carried out solely on the basis of internal measurements on the liquid cooling device. The latter can therefore be configured autonomously. The distribution of the mass flow of liquid to be cooled into the first path and the second path and the rotational speed control of the at least one fan allows the liquid cooling apparatus to be able to automatically react to changes in the thermal input power, i.e. the waste heat power of the fuel cell apparatus, and the ambient temperature. The liquid cooling apparatus does not have to receive any external open-loop or closed-loop control signals in order to be able to carry out the control. The liquid cooling apparatus can be started up rapidly by switching on a (circulating) pump to convey the liquid in the liquid cooling apparatus. A fuel cell device can be rapidly heated up, in this case, to an optimised operating temperature, as the second path (bypass path) is available.

A gentle temperature transition from the rapid heating up to a control of the temperature of the liquid by the combination of the temperature-controlled two-way valve and the at least one speed-controlled fan can be achieved.

The liquid cooling apparatus according to the invention can be realised in a scaled manner. For example, the thermal cooling power can be adjusted by means of the number of fans provided.

The liquid cooling apparatus according to the invention can be advantageously used for PEFC systems. Cooling powers in the order of magnitude of between 800 W and 2000 W can easily be realised, for example.

It is quite particularly advantageous if the two-way valve is configured as a three/two-way valve, which has three connections (an inlet connection, which is connected to the inlet connection of the liquid cooling apparatus) and two outlet connections, to define the first path and the second path.

It is quite particularly advantageous if at least one temperature sensor is associated with the two-way valve, the two-way valve being controlled on the basis of measured temperature values of the at least one temperature sensor. A liquid cooling system can thereby be realised, which, in particular, does not have to exchange any control information with the fuel cell device. The measured temperature values directly measured on the liquid ensure the corresponding adjustment of the distribution of the liquid mass flows into the first path and the second path.

In particular, the two-way valve has a detecting element (probe), on which the at least one temperature sensor is arranged. The detecting element measures the temperature of liquid in the liquid cooling apparatus at a suitable point.

In one embodiment, the at least one temperature sensor is associated with a liquid reservoir. It measures the temperature of liquid, which flows into the liquid reservoir or which is located in the liquid reservoir. The liquid reservoir is a liquid buffer reservoir, in which cooled liquid is stored. A temperature control of the two-way valve can thus be achieved in a simple manner.

For example, the at least one temperature sensor is arranged in such a way that an inlet temperature into a liquid reservoir can be measured or in that a temperature in the liquid reservoir can be measured. The two-way valve can thereby be directly controlled by means of this measured temperature.

In an alternative embodiment, the at least one temperature sensor is arranged in such a way that an outlet temperature following a pump can be measured. In particular, the at least one temperature sensor is then arranged in such a way that a temperature at or close to an outlet connection is measured.

It is quite particularly advantageous if the two-way valve is configured as a thermostat valve and/or as a thermo-hydraulic valve. The control of the two-way valve can thus be brought about in a simple manner. The two-way valve does not then have to be configured as an electronically controllable valve. A valve position to distribute the liquid mass flow directly by means of measured temperature values can be controlled in a thermo-hydraulic valve.

It is favourable if a pump is operated to convey liquid in an uncontrolled manner to a mass flow working point. It may be advantageously provided, in this case, that this working point itself can be adjusted. During operation of the liquid cooling apparatus, it is then ensured that liquid for cooling is then provided at a constant mass flow to the fuel cell device. As a result, no changes in the heat transfer into a fuel cell block occur (at different temperatures or thermal powers). Moreover, the reliability of the pump is thereby increased as the risk of pump faults is reduced with constant running without rotational speed fluctuations.

In particular, an internal liquid reservoir is provided. The liquid cooling apparatus thus comprises a buffer store, which contains cooled liquid.

A filter device is favourably provided, which is arranged downstream of the inlet connection. In particular, this filter device comprises an ion exchanger, for example with a fixed bed filter. The operating reliability is thereby increased. In particular, the filter device is detachably arranged, for example by means of a quick plug-in connection, to allow a simple filter exchange.

It is quite particularly advantageous if associated with the at least one fan is its own temperature sensor. If a plurality of fans is provided, a respective temperature sensor is then associated, in particular, with each individual fan. A rotational speed control for each fan can thus be realised in a simple manner. The temperature sensor associated with a fan in particular measures the air temperature at an air flow of the radiator, the temperature sensor being advantageously arranged in such a way that the radiator is located between it and the fan.

It is furthermore favourable if associated with the at least one fan is its own speed controller. A power adaptation with respect to the cooling power can be achieved by means of a rotational speed control of the fan. As a result, for example, a heating-up phase can be taken into account and fluctuations in the ambient temperature can also be easily taken into account.

In an advantageous embodiment, a plurality of fans is provided, which are speed-controlled individually and preferably independently of one another. It is thereby possible to obtain a cooling power which is adapted depending on the temperature of the cooling medium to be cooled, in that the number of active fans is selected accordingly.

It is advantageous if a switching device is provided by means of which one or more fans can be switched on or off. If, for example, a specific threshold temperature for the liquid is exceeded, one or more fans or banks of fans can then be switched on in order to achieve stronger cooling. When the temperature is lowered, the corresponding fans can then be switched off again.

It is quite particularly advantageous if the fan is operated, when switched on, at a finite minimum rotational speed, i.e. if, when switching on the fans, they do not have to be started up from a rotational speed of 0, but are already operated at the minimum rotational speed.

A temperature sensor is favourably provided, which measures the temperature of the liquid in the first path (before entry into the radiator), it being possible to switch a fan on or off on the basis of the measured temperature values. An autonomous liquid cooling apparatus can thus be provided, the control of which is based on internal measurements.

In one embodiment, a favourable operating mode is provided, in which, below a first threshold temperature for the liquid to be cooled, the liquid is guided by the two-way valve into the second path. The radiator is thus bypassed in a bypass line.

As too strong a cooling of the liquid is prevented, a fuel cell block can thus be rapidly heated up.

In this operating mode, in particular, at least one fan is operated at a finite minimum rotational speed. A gently temperature transition from the rapid heating up to a control of the temperature of the liquid can thus be achieved. The at least one fan does not have to be started up from the rotational speed of zero.

It is furthermore favourable if an opening of the two-way valve takes place with a temperature-controlled distribution of the mass flow of liquid into the first path and the second path when the first threshold temperature is exceeded. An effective cooling can thus be achieved adapted to the instantaneous conditions.

In particular, a rotational speed control of the at least one fan takes place when the first threshold temperature is exceeded. When the temperature is increased, the at least one fan is operated at an increased rotational speed in order to achieve effective cooling.

It is furthermore favourable if at least one further fan is switched on when a second threshold temperature, which is above the first threshold temperature, is exceeded. The number of effective fans can thus be easily increased to bring about effective cooling.

In particular, the at least one fan is switched on at a finite minimum rotational speed, so a “gentle temperature transition” is achieved, as the corresponding at least one fan does not have to be started up from the rotational speed of zero.

It is favourable if an alarm device is provided to monitor operation. As a result, the liquid cooling apparatus can be monitored with respect to parameters which can no longer be corrected, in order, for example, to bring about an emergency switch-off.

The alarm device, in particular, comprises a plurality of limit monitors connected one behind the other. If critical conditions are then reached at any one of these limit monitors, an alarm is emitted.

In particular, the alarm device comprises a temperature monitor for an inlet temperature of the liquid and/or a filling level monitor on a liquid reservoir and/or a minimal through-flow monitor for liquid. If the temperature monitor for the inlet temperature indicates that the liquid flowing into the liquid cooling apparatus is too hot, an emergency switch-off is necessary. If the filling level monitor indicates that too much or too little liquid is located in the liquid reservoir, an emergency switch-off is also sensible. If the minimal through-flow monitor indicates that too little liquid is conveyed, an emergency switch-off is also necessary.

A liquid coupling blocking both ways is associated, in particular, with the inlet connection and/or the outlet connection. The liquid cooling apparatus can thus be connected in a simple manner, as an autonomous module, to connections of a fuel cell device.

It is quite particularly advantageous if the liquid cooling apparatus is configured autonomously, a temperature control for the cooling being based on internal measurements. The liquid cooling apparatus thus does not have to receive any open-loop or closed-loop control signals from a fuel cell device or a control device of a fuel cell system. The liquid cooling apparatus can thus be used universally.

In one embodiment, a circuit is provided, in which heated liquid can be provided to a hydrogen sorption storage device for the desorption of hydrogen. Basically, heated liquid is introduced into the liquid apparatus according to the invention. A partial flow of this heated liquid can be used to provide hydrogen by means of desorption in a hydrogen sorption storage device.

A heat transfer device, which is in thermal contact with the hydrogen sorption storage device, is arranged in the circuit. The heat transfer device may in this case be integrated into the hydrogen sorption storage device.

In particular, the circuit is connected downstream here from the inlet connection for liquid, so a corresponding partial flow can be branched off and used.

It is favourable if a switching valve for the through-flow of a heat transfer device for the liquid is arranged in the circuit and is temperature-controlled. In particular, the temperature is controlled by means of the temperature of the liquid. As a result, the through-flow of the heat transfer device can be blocked by means of the switching valve if a temperature threshold is fallen below. If the liquid is “too cold” the hydrogen sorption storage device in the relevant region can then be prevented from being cooled below the desorption temperature of hydrogen. The switching valve is realised, for example, by a control valve with an adjustable switching threshold.

It is favourable if a mixing device is provided, by means of which a flow of heated liquid, which is provided by the inlet connection, and a flow from the hydrogen sorption storage device can be mixed and the mixture can be provided to the two-way valve. The liquid, which comes from the hydrogen sorption storage device, is cooled because of the heat dissipation to the hydrogen sorption storage device. Because of a corresponding mixture, the temperature of the liquid to be cooled can be reduced.

It is furthermore favourable if a distribution apparatus is provided, by means of which a liquid flow, which is provided by the inlet connection, can be divided into a partial flow for the circuit and into a further partial flow. Only one partial flow to provide the hydrogen is thus branched off. The other partial flow is introduced, for example, in a mixing device, in which liquid cooled at the hydrogen sorption storage device is introduced.

In one embodiment, a pump is arranged in the circuit. A defined hydrogen provision by means of desorption can thus be achieved, in particular in conjunction with an adjustment of the mass through-flow.

It is favourable if a liquid container is connected upstream of the pump. Cavitation at the pump can thus be avoided.

It is basically possible for a purely thermo-hydraulic use or use by means of an expanding material element of heated liquid for the hydrogen desorption to take place in the circuit. It may also be provided that a flow adjustment device, by means of which the mass flow of heated liquid can be adjusted in the circuit, is arranged in the circuit.

According to the invention, a fuel cell system is also provided, which comprises a fuel cell device and a liquid cooling apparatus according to the invention, the liquid cooling apparatus being connected to the fuel cell device in a fluid-active manner (with regard to the configuration of a circuit for cooling liquid).

The following description of preferred embodiments is used, in conjunction with the drawings, for a more detailed description of the invention.

### BRIEF DESCRIPTION OF THE DRAWINGS

FIG. 1 shows a schematic view of an embodiment of a fuel cell system;

FIG. 2 shows a schematic block diagrammatic view of an embodiment of a liquid cooling apparatus according to the invention;

FIG. 3 shows a variant of the liquid cooling apparatus according to FIG. 2;

FIG. 4 shows a schematic view of different operating modes as a function of the temperature T, the continuous curve indicating the number N of operated fans and D the rotational speed of operated fans;

FIG. 5 shows a further embodiment with a connected hydrogen sorption storage device; and

FIG. 6 shows a variant of a liquid cooling apparatus with a connected hydrogen sorption storage device.

### DETAILED DESCRIPTION OF THE INVENTION

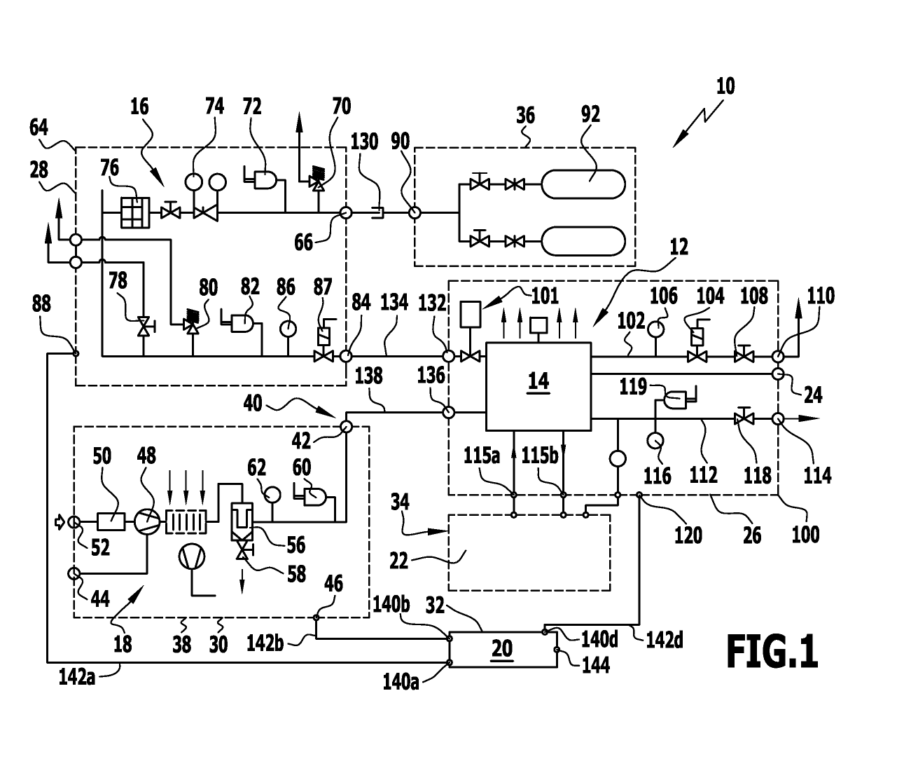

An embodiment of a fuel cell system, which is shown in FIG. 1 and is designated 10 there, comprises a fuel cell device 12 with one or more fuel cell blocks 14. The fuel cell device 12 is the fuel cell core device of the fuel cell system 10. The fuel cell system 10 furthermore comprises a fuel supply device 16, by means of which the fuel cell block(s) 14 of the fuel cell device 12 can be supplied with fuel.

Furthermore, the fuel cell system 10 comprises an oxidator supply device 18 for the fuel cell device 12, by means of which oxidator can be provided to the fuel cell block(s) 14.

A control device 20 is provided to control the fuel cell system 10.

A cooling device 22 is associated with the fuel cell block(s) 14.

The fuel cells of the fuel cell block(s) 14 are, in particular, polymer membrane fuel cells (PEFCs), in which the electrolyte is formed by a proton-conducting membrane. Apart from the function of the electrolyte, the membrane is also the catalyst carrier for the anodic and cathodic electrocatalysts and is used as a separator for the gaseous reactants. Hydrogen is used as the fuel and oxygen, and in particular air oxygen, is used as the oxidator. Air with air oxygen as the oxidator is then supplied to the fuel cell device 12.

Chemical energy is converted by the cold combustion of the fuel with the oxidator into electrical energy in the fuel cell block(s) 14. This electrical energy can be delivered by means of a connection 24 to a consumer.

The fuel cell system 10 is configured in a modular manner with a fuel cell device module 26, a fuel supply device module 28 and an oxidator supply device module 30.

A control device module 32 is furthermore provided, which comprises the control device 20.

The cooling device 22 is integrated into a cooling device module 34, which is described in more detail overleaf.

A fuel storage module 36 is provided in the embodiment shown.

It is alternatively also possible for the fuel store to be integrated into the fuel supply device module 28.

The functional components of the oxidator supply device 18 are integrated into the oxidator supply device module 30. The oxidator supply device module 30 has a closed housing 38. The housing may be gas-tight. For example, the housing is transparent. A possible material is Plexiglas.

The oxidator supply module 30 is provided with a communication interface 40, which has an outlet connection 42, by means of which oxidator can be discharged. In particular, air as the oxidator carrier with air oxygen as the oxidator can be discharged.

Furthermore, an electrical connection 44 is provided, by means of which electrical energy can be introduced into the oxidator supply device module 30 for provision to electrical consuming elements of this module.

Furthermore, a signal connection 46 may be provided to introduce control signals.

The corresponding connections 42, 44 and 46 are arranged on the housing 38.

Arranged in the housing 38 is an air compressor 48. A filter 50 is connected upstream thereof. The housing 38 has one or more air supply openings 52, by means of which air can be supplied to the air compressor 48, the filter 50 having to be passed by the supplied air. An air conveyor and cooler 54, which is driven, in particular by an electric motor, is arranged at the air supply opening(s) 52.

A water separator 56 is connected downstream of the air compressor 48 in the housing 38. Air guided through the oxidator supply device module 30 can be dehumidified by means of this water separator 56. An adjusting element 58, which is connected to an outlet, by means of which water can be discharged, is associated with the water separator 56, in this case.

The oxidator supply device module 30 also comprises a pressure switch 60 and a pressure indicator 62. A specific air pressure/air flow of the air compressor 48 can be checked by means of the pressure switch 60. This air pressure/air flow is fixedly predetermined by an adjusting apparatus (such as, for example the adjusting valve 118). The air flow can be discharged at the outlet connection 42.

To adjust the supply device module 30, an adjusting device can also be directly connected to the module 30 and/or only connected temporarily.

The oxidator supply device module 38 forms a unit which can be positioned as a whole. The connection to the control device module 32 takes place by means of the communication interface 40. The connection to the fuel cell device module 26 takes place by means of the connection 42 (as the material flow interface). Electrical consumption elements of the oxidator supply device module 30 are supplied by means of the control device module 32 with electrical energy (which is introduced at the electrical connection 44).

The fuel supply device module 28 has a housing 64, in which the functional components of the fuel supply device 16 are arranged. The housing 64 is, in particular, closed and gas-tight. It is preferably provided that guides for fuel are configured without tubes within the fuel supply device module 28. For example, the housing 64 is formed by means of a plastics material block and the corresponding flow guides are formed by bores in the plastics material block. A type of bus system is thus provided for the flow guidance of the fuel within the fuel supply device module 28.

Fuel stores are arranged outside the fuel supply device module 28 in the embodiment shown in FIG. 1. Its own fuel storage module 36 is provided for this purpose. In order to be able to introduce fuel, which is supplied by the fuel storage module 36, a connection 66 for introducing fuel is provided on the housing 64. This connection 66 has a fluid-active connection to a fuel guide 68 within the housing 64. A safety valve 70 is coupled to this fuel guide 68. A pressure switch 72 is also provided, by means of which the pressure of the fuel guided within the housing 64 (in particular hydrogen) can be checked. A pressure reducing/adjusting apparatus 74 with a pressure indicator is connected downstream of the pressure switch 72. Furthermore, a flame arrester 76 is provided.

Following the flame arrester 76, a discharge valve 78 is arranged in the fuel guide 68. Gaseous fuel located in the housing 64 can be discharged by means of the discharge valve 78.

A further safety valve 80 is furthermore provided.

The pressure of fuel which can be discharged at a connection 84 can be checked by means of a further pressure switch 38. This pressure can be displayed by means of a pressure indicator 86. A following valve 87 allows safe blocking of the outlet connection 84.

The fuel supply device module 28 has a communication interface, which comprises the connections 66 and 84. Furthermore, a control signal connection 88 may be provided. An electrical connection may be provided (not shown in FIG. 1) to introduce electrical energy for provision to electrical consumption elements of the fuel supply device module 28.

The fuel supply device module 28 forms a unit, which can be positioned as a whole.

The fuel storage module 36 has an interface 90, by means of which fuel can be discharged (or introduced) and, in particular, can be supplied to the fuel supply device module 28. The fuel storage module 36 has one or more fuel stores 92, in which, for example, hydrogen is stored as a gas.

One or more metal hydride stores may also be provided. A metal hydride store of this type is, in particular, formed by means of an extruded profile.

A metal hydride store of this type may be a structural element of the fuel cell system 10 or an application. As the metal hydride store with its extruded profile can be mechanically loaded, it can also adopt a carrying function, for example in a vehicle in order to support vehicle parts or to hold the fuel cell system 10 with its modules or to hold individual modules of the fuel cell system 10.

The fuel storage module 36 is, in particular, arranged and configured in such a way that it is exchangeable. After emptying, it can be removed and a new fuel storage module 36 can be inserted with a filled fuel store 92 or filled fuel stores 92.

It is also possible for fuel stores to be integrated into the housing 64 of the fuel supply device module 28. No separate fuel storage module 36 then has to be provided, but a combination module is formed, which comprises the fuel supply device 16 and the fuel store(s). A fuel supply device module of this type in principle has the same functional components as described with the aid of the fuel supply device module 28.

It is provided, in particular, that the fuel, which can be discharged at the connection 84, is adjusted to a fixed pressure value predetermined by means of the pressure switch 82. This pressure value is displayed by means of the pressure indicator 86.

The fuel cell device module 26 has a housing 100. The housing is, in particular, closed with defined cooling medium guidance. It is transparent, for example.

A fuel primary pressure control device 101, which is arranged in the housing 100, can be connected upstream of the fuel cell block(s) 14.

Arranged in the housing 100 are the fuel cell block(s) 14. A fuel discharge line 102 is also arranged in the housing 100. A (blocking) valve 104 with time control is seated on this discharge line 102. This is, in particular, an electromagnetic valve. The pressure is displayed by means of a pressure indicator 106.

Furthermore, an adjusting valve 108 may be provided, with which the pressure drop when opening the valve 104 can be adjusted.

The discharge line 102 opens into an outlet connection 110, by means of which unused fuel can be discharged.

An oxidator discharge line 112 and, in particular, air discharge line, is also arranged in the housing 100. The latter opens into an outlet connection 114. A pressure indicator 116 is coupled to the discharge line 112. An adjusting valve 118 is also provided in order to be able to adjust the volume flow of the discharged air.

A temperature switch 119 may be provided on the discharge line 112.

The fuel cell device module 26 has an inlet connection 115a, by means of which a liquid can be introduced as a cooling medium into the fuel cell block(s) 14. Furthermore, an outlet connection 115b is provided, by means of which heated cooling medium can be discharged. The cooling device module 34 can be connected to the inlet connection 115a and the outlet connection 115b.

The fuel cell device module 26 has a control signal connection 120, by means of which control signals can be introduced. In particular, the valve 104 (which is a blocking valve) can be activated in this case. This blocking valve 104 is controlled in such a way that it is either open or closed. It can be controlled in a clocked manner and, in this case, can be opened in a clocked manner in such a way that a fuel relief is ensured from the fuel cell block 14.

The connection 24, by means of which external electrical consumers are supplied with electrical power, is arranged on the housing 100.

Electrical connections may also be provided (not shown in FIG. 1), by means of which electrical power can be introduced for internal consumers of the fuel cell device module 26.

A communication interface for the fuel cell device module 26 is formed by means of the described connections.

The fuel cell device module 26 forms a unit, which can be positioned as a whole separately from the other modules.

A separate cooling device module 34 is provided, which can be coupled to the fuel cell device module 26.

The fuel cell device module 26, the fuel supply device module 28, the oxidator supply device module 30, the control device module 32 and the cooling device module 34 can be positioned separately and independently of one another. Communication with one another takes place by means of the corresponding interfaces:

A coupling 130 and in particular a rapid coupling are provided, for example, for direct coupling of the fuel storage module 36. A fuel line is then formed by means of this coupling.

It is also possible for a connection to take place by means of a line, which is coupled to the connection 66 of the fuel supply device module 28 and is coupled to the interface 90 of the fuel storage module 36.

The fuel supply device module 28 communicates with the fuel cell device module 26 by means of its outlet connection 84 for fuel. Fuel can be introduced at an inlet connection 132 of the fuel cell device module 26. To guide the fuel between the fuel supply device module 28 and the fuel cell device module 26, a line 134 is provided, which is an element that is separate from the two modules. The line is selected according to the position and spacing of the two modules.

Air with air oxygen as the oxidator can be discharged at the outlet connection 42 of the oxidator supply device module 30. The fuel cell device module 26 has an inlet connection 136, by means of which air can be introduced. The connections 42 and 136 can be connected by a line 138, this line 138 being an element separate from the oxidator supply device module 30 and the fuel cell device module 26.

The control device module 32 also forms a unit, which can be positioned as a whole independently of the other modules. It has corresponding connections 140a, 140b, 140c, 140d, by means of which control signals can be output to modules which can be loaded with control signals. Control signal lines 142a etc. can be coupled to the connections in order to be able to transmit the control signals.

Furthermore, the control device module 32 has one or more connections 144 for electrical energy. Electrical energy can be output from these and can be coupled by corresponding lines to corresponding energy connections of the modules. As a result, electrical consumers of the corresponding modules can be supplied with energy.

The fuel cell system 10 functions in such a way that supply parameters of fuel are rigidly predetermined (by means of the fuel supply device module 28) and of the oxidator (by means of the oxidator supply device module 30), the pressure of the fuel supplied to a fuel cell block 14 being predetermined on the supply side, a continuous hydrogen discharge from a fuel cell block 14 being blocked and a quantity of fuel supplied to a fuel cell block 14 being controlled by the power consumption of an (external) consumer.

A method of this type and further method details and the detailed configuration of the corresponding fuel cell system are described in DE 100 27 600 A1 and DE 100 27 600 C2 and DE 101 27 599 A1 and DE 101 27 599 C2. Reference is made to these documents.

In particular, a sequence control is formed by means of the control device 20 and transmits preadjusted control signals. A control of the supply is unnecessary in the described method implementation.

The fuel cell system is composed of sub-systems which are independent at least with regard to the positionability, namely the fuel cell device module 26, the fuel supply device module 28, the oxidator supply device module 30, the control device module 32 and the cooling device module 34.

The modules have defined interfaces to communicate with other modules. The modules are separate. The corresponding functional components are rigidly arranged therein so a module can be positioned as a unit. Connecting elements and in particular lines connect cooperating modules with one another.

The operating parameters and in particular material flows, electrical currents and signal flows can be adjusted separately per module.

The modules can be produced separately.

A safety-relevant aspect is the fuel guidance in the fuel cell system 10. Owing to the modular mode of construction, the fuel cell system 10 is not involved as a whole, however, but only the modules in which fuel is guided, i.e. the fuel supply device module 28 (optionally also the fuel storage module 36) as well as the fuel cell device module 26 and the line 134. Within the fuel cell device module 26 and the fuel supply device module 28, the fuel can be guided, for example, in bores, which are formed by recesses in a solid material. No tubes are thus necessary, which may leak. The corresponding modules 26 and 28 may also be gas-tight, while the entire fuel cell system 10 then no longer has to be gas-tight.

Furthermore, the modules 26 and 28 may be provided with a safety ventilation to the environment outside the total system.

Owing to the modularisation of the fuel cell system 10, the latter can be constructed flexibly. In particular, an adaptation to geometric circumstances is possible. Each module can be optimised individually.

The lines between modules are independent of the modules. They can be connected to the modules, for example, by means of safety couplings, if material transport lines are provided.

An easy repair or exchange of components of the fuel cell system 10 is also possible, as modules can be exchanged as a whole. For example, a fuel supply device module and/or a fuel storage module is exchanged as a whole.

Furthermore, the fuel cell system 10 can also be easily disassembled and assembled.

In particular if metal hydride stores are used, a fuel store or a fuel store module may also form a structural element of an application. In particular, a metal hydride store of this type can be used as a carrying structural element. The necessary fuel is, in this case, also carried “on board”. The necessary oxidator comes from the ambient air.

According to the invention, a simple fuel cell system 10 is provided, which is, in particular, air-cooled. It can be flexibly integrated into an application because of its modular structure. Operation does not have to be supervised.

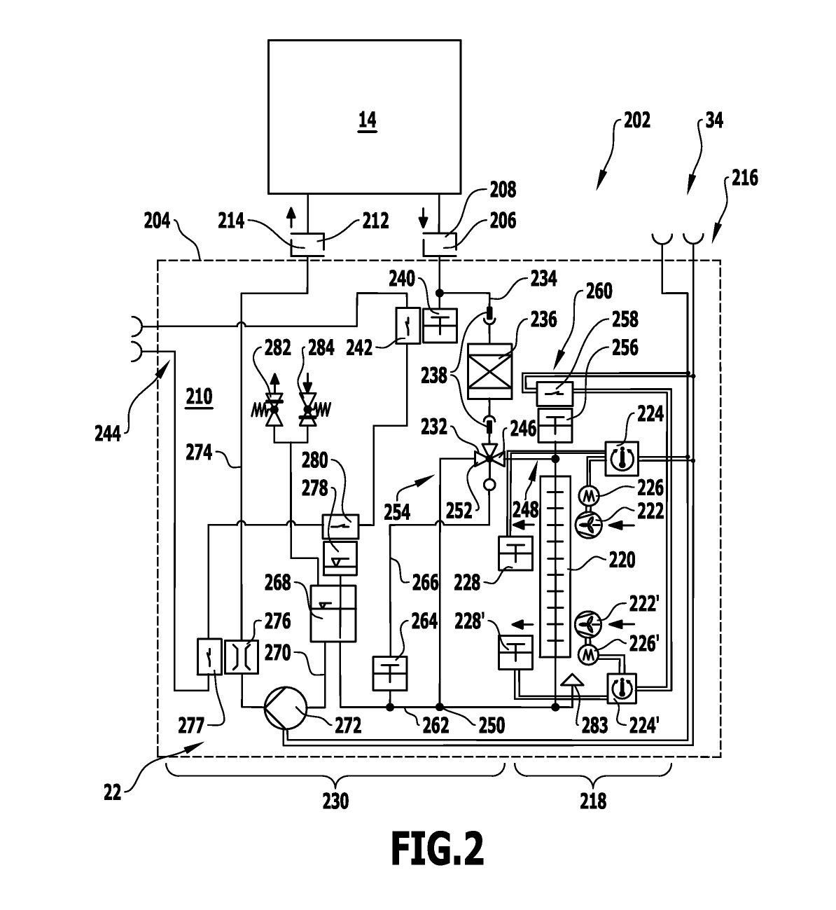

An embodiment of a liquid cooling apparatus according to the invention, which is shown in a schematic view in FIG. 2 and is designated 202 there, is configured as a cooling device module 34. The liquid cooling apparatus 202 has a (closed) housing 204. The cooling device 22 is arranged in this housing 204.

An inlet connection 206 for liquid (to be cooled) is arranged on the housing. In particular, the inlet connection 206 is formed by a liquid coupling 208 which blocks on both sides. Liquid can be introduced into an interior 210 of the housing 204 by means of the inlet connection 206.

Furthermore, an outlet connection 212 for (cooling) liquid is arranged on the housing 204. The outlet connection 212 is, in particular, formed by a liquid coupling 214 which blocks on both sides. The inlet connection 206 can be connected to the outlet connection 115b of the fuel cell device 14. The outlet connection 212 can be connected to the inlet connection 115a of the fuel cell device 14. The closed state is indicated in FIG. 2.

Furthermore, a connection device 216 for the electric current supply for the liquid cooling apparatus 202 is arranged on the housing 204. Electrical energy can be provided by means of the connection device 216.

As will be described in more detail, no signal connections are basically necessary in the liquid cooling apparatus 202 according to the invention for introducing external open-loop and/or closed-loop control signals. The liquid cooling apparatus 202 is configured as a self-controlling autonomous system.

The cooling device 22 comprises a first assembly 218 (radiator-assembly) with a radiator 220 and at least one fan 222, which is oriented in such a way that its air flow impinges on the radiator 220. In a preferred embodiment, a plurality of fans is provided, which are arranged, for example, in a row along the radiator 220. The number of fans 22 depends on the power of the fuel cell block(s) 14, which are to be cooled.

In a specific embodiment of a liquid cooling apparatus 202 with a thermal power of 880 W, four fans 222 are provided. With a thermal power of 1200 W, at least five fans 222 are provided.

Each fan 222 is individually speed-controlled. For this purpose, a speed controller 224 is provided, which controls a fan motor 226.

Associated with each fan 222 is its own temperature sensor 228. For example, the radiator 220 is located between a respective temperature sensor 228 and a fan 222.

The respective temperature sensor 228 is coupled to the associated speed controller 224 and provides it with measured temperature values.

Further fans are indicated in FIG. 2 by the reference numerals 222′.

The temperature sensors 228, 228′ in particular measure the air temperature at the radiator 220 in the air flow of the associated fan 222.

Furthermore, the cooling device 22 comprises a second assembly 230, which comprises elements for the circuit guidance of liquid in the housing 204.

Arranged in the housing 204 is a two-way valve 232, which is configured, in particular, as a three/two-way valve with three connections and two flow paths. The two-way valve 232 is an internal valve of the module 34. A line 234 for liquid leads from the inlet connection 206 to an inlet of the two-way valve 232. Arranged on the line 234 is a filter device 236, which, in particular, comprises an ion exchanger fixed bed filter. The filter device 236 is positioned by means of a detachable connection, such as, for example, a plug coupling 238. Easy exchange is thereby made possible.

Also arranged on the line 234 is a temperature sensor 240, with which a limit monitor 242 is associated. The temperature sensor 240 measures the temperature of the liquid flowing in by means of the inlet connection 206. The limit monitor 242, as will be described in more detail below, is part of an alarm device 244 for monitoring the operation of the liquid cooling apparatus 202.

A first (flow) path 248 is formed by means of a first outlet 246 of the two-way valve 232. It comprises one or more lines and leads from the first outlet 246 through the radiator 220 to a collecting point 250. A second (flow) path 254 is formed by a second outlet 252 of the two-way valve 232. It comprises a line, which leads from the second outlet 252 to the collecting point 250.

A temperature sensor 256 is arranged on a line of the first path 248 and measures the temperature of the liquid in the first path 248 before entry into the radiator 220. Associated with the temperature sensor 256 is a switch 258, which is part of a switching device 260. This switch 258 supplies a switching signal when a specific temperature threshold is exceeded (as will be described in more detail below), to one or more speed controllers. In the embodiment shown, the switch 258 is coupled to the speed controller 224′.

The collecting point 250 is arranged on a line 262. A temperature sensor 264, which is coupled to the two-way valve 232, is seated on this line 262. The temperature sensor 264 measures the temperature of liquid, which has left the radiator 220. Corresponding temperature signals are provided to the two-way valve 232. The two-way valve 232 is temperature-controlled on the basis of the measured temperature values of the temperature sensor 264.

It is basically possible for the two-way valve 232 to be an electronically controlled valve. In a preferred embodiment, the two-way valve is configured as a thermostat valve and, in particular, a thermo-hydraulic valve. The temperature sensor 264, which is a detector for the two-way valve 232, is then connected by a hydraulic line 266 to the two-way valve 232. The measured temperature directly determines the valve position of the two-way valve 232 by means of a hydraulic liquid in the hydraulic line 266.

The valve position of the two-way valve 232 in turn determines the mass flow distribution of liquid, which comes from the at least one fuel cell block 14, into the first path 248 and the second path 254. In this case, the second path 254 is a bypass path, which bypasses the radiator.

The two-way valve 232 can preferably be adjusted in such a way that a temperature can be adjusted, at which it opens to the first path 248, i.e. the temperature can be adjusted at which a mass flow division into the first path 248 and the second path 254 begins.

The line 262 leads to a liquid reservoir 268 arranged within the housing 204. Cooled liquid can be buffer-stored in the liquid reservoir 268.

A line 270 leads from the liquid reservoir 268 to a (circulating) pump 272.

The circulating pump 272 is operated to a fixed working point. It ensures the conveyance of liquid through the liquid cooling apparatus 202. The liquid is, in this case, transported in a constant mass flow when the pump 272 is adjusted to a fixed working point (and in particular uncontrolled).

It is basically possible here for this working point to be adjustable.

A line 274 leads from the pump 272 to the outlet connection 212. A minimal through-flow monitor 276 with a limit monitor 277, which checks whether a minimal through-flow, i.e. a through-flow above a specific limit value has been reached, is arranged on the line 274. This minimal through-flow monitor 276 is part of the alarm device 244.

A filling level gauge 278 with a limit monitor 280 is associated with the liquid reservoir 268. Whether the liquid level in the liquid reservoir 268 is within a specific range is monitored. The limit monitor 280 is part of the alarm device 244.

An excess pressure safety valve 282 and a negative pressure safety valve 284 are associated with the liquid reservoir 268.

The alarm device 244, as mentioned, comprises the limit monitor 242, the limit monitor 280 and the limit monitor 277, which is associated with the minimal through-flow monitor 276. These are connected serially. If a limit value is exceeded (through-flow too low and/or liquid level too low or too high and/or temperature of liquid entering the liquid apparatus 202 too high), an alarm signal is emitted, which leads, for example, to an emergency switch-off.

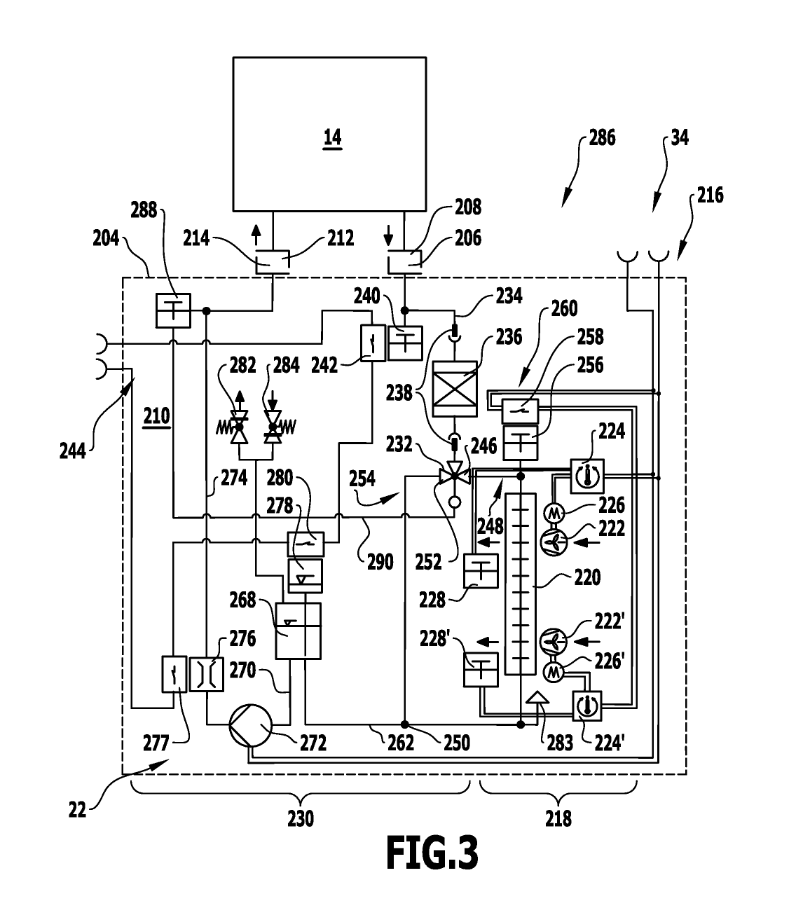

A further embodiment of a liquid cooling apparatus according to the invention, which is shown schematically in FIG. 3 and designated 286 there, is a variant of the liquid cooling apparatus 202. It differs in the arrangement of temperature sensor, which is connected to the two-way valve 232. Otherwise, all the elements are configured identically and are designated by the same reference numerals.

A corresponding temperature sensor 288 is arranged directly before the outlet connection 212. It is connected by a hydraulic line 290 to the two-way valve 232. The temperature sensor 288 measures the temperature of the liquid in the line 274.

A vent 283 and, in particular an automatic vent, is arranged on the line 262.

It is basically also possible for the corresponding temperature detector, which is connected to the two-way valve 232, to have a temperature sensor, which is arranged directly in the liquid reservoir 268 (not shown in the drawing), and therefore for it to measure the temperature of the liquid in the liquid reservoir 268.

The liquid cooling apparatus according to the invention functions as follows:

The liquid cooling apparatus is configured as an autonomous cooling device module 34, which can be connected to the fuel cell device 12. The fuel cell system with the fuel cell device 12 may, in this case, be modularly constructed or else be non-modularly constructed.

The liquid cooling apparatus 202 is coupled by the inlet connection 206 and outlet connection 212. Liquid, which is provided by the fuel cell device 12 can flow through the cooling device 22, be cooled in the process and again provided to the fuel cell device 12.

The introduced liquid flows through the filter device 236. The liquid may be, for example, desalinated water, drinking water or water with additives such as antifreeze agent and/or corrosion protection agent.

If necessary, cleaning takes place at the filter device 236.

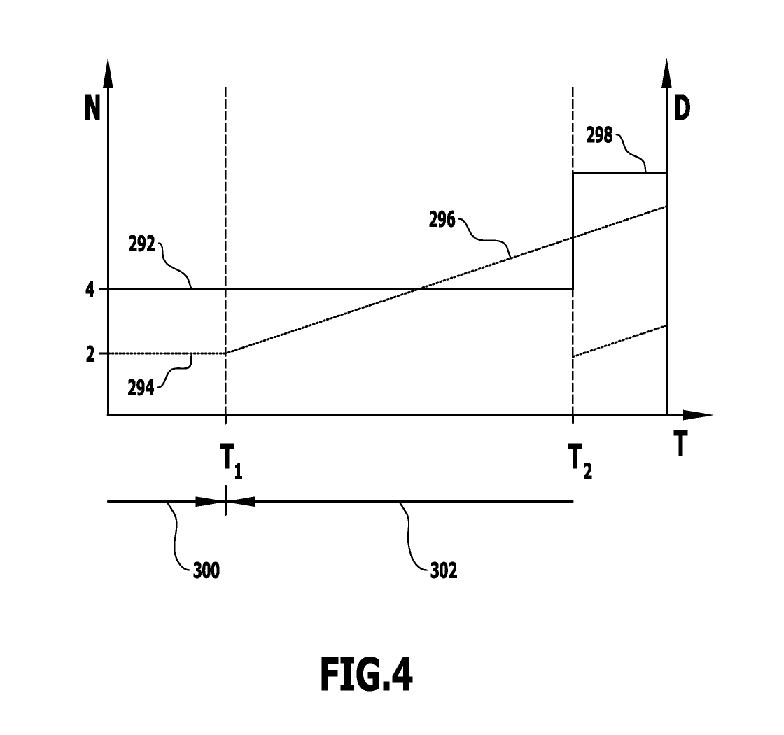

The liquid then flows to the two-way valve 232, which is temperature-controlled. Below a minimum temperature threshold T₁ (FIG. 4), the two-way valve 232 is closed, the first pump 248 being blocked. The liquid then flows in the second path 254 without mass flow division to the collecting point 250 and from there into the liquid reservoir 268.

The first temperature threshold T₁ is, for example, in the order of magnitude of 30° C. When this temperature threshold is fallen below, no cooling is necessary.

Below the first temperature threshold T₁, a minimum number of fans 222 is switched on. This is indicated in FIG. 4 by the reference numeral 292; in this embodiment, two fans are connected. These rotate at the minimum rotational speed 294. If the temperature threshold T₁ is exceeded, the two-way valve 232 opens and a temperature-dependent mass flow distribution into the first path 248 and the second path 254 tales place. As below the first temperature threshold T₁, a minimum number of fans 222 is driven at the minimum rotational speed 294, i.e. as from the start of operation the fan(s) 222 are already operated at the minimum rotational speed 294, a “continuous” transition can be achieved. Above the first temperature threshold T₁, the fan(s) 222 (two fans in the example according to FIG. 4) are then speed-controlled and when the temperature increases, as measured, for example, by the temperature sensor 228, the rotational speed also increases. This is indicated in FIG. 4 by the curve 296.

If an upper temperature threshold T₂, which is, for example, in the order of magnitude of 45° C., is exceeded, further fans are switched on, triggered by the temperature sensor 256 and the switch 258. This is indicated in FIG. 4 by the curve with the reference numeral 298. Two further fans are, for example, additionally switched on. These are firstly operated at the minimal rotational speed when being switched on and a rotational speed control then takes place when the temperature is further increased.

The number of actually used fans 222 depends on the thermal power of the liquid cooling apparatus 202.

The pump 272 pumps liquid at a constant mass flow through the liquid cooling apparatus 202. The fuel cell device 12 can thus also be provided with cooling liquid at a fixed mass flow (which is, however, basically adjustable).

The temperature-controlled two-way valve 232 is configured as a thermostat valve and, in particular, a hydraulic thermostat valve. Self-regulation occurs; the liquid temperature measured by the temperature sensor 264 or 288 brings about a control feedback and controls the valve position of the two-way valve 232.

FIG. 4 indicates the closed two-way valve 232 by the arrow with the reference numeral 300. In this case, the liquid is conveyed in the bypass path 254. Above the first temperature threshold T₁ (arrow 302) the two-way valve 232 is opened and a mass flow division into the first path 248 and the second path 254 takes place depending on the temperature, the higher the temperature of the liquid to be cooled, the more liquid is distributed to the first path 248.

The alarm device 244 monitors the liquid cooling apparatus 202 in such a way that no limit values are exceeded.

Owing to the solution according to the invention, a liquid cooling apparatus is provided, which has a simple and economical system structure.

A constant (preferably adjustable) mass flow of cooling liquid is provided in a simple manner to the fuel cell device 12. No changes in the heat transfer within a fuel cell block 14 thus occur at various temperatures or various thermal powers, as the mass flow does not vary.

As the pump 272 is operated at a constant rotational speed, the latter has a high degree of reliability.

Furthermore, the mass flow distribution can be realised by a thermo-hydraulically activated two-way valve 232 with a high degree of reliability. No electronic partial system control of its own is necessary for the mass flow distribution.

Furthermore, no exchange of control information has to take place between the fuel cell device 12 and a superordinate control device 20. The liquid cooling apparatus 202 is autonomous.

The liquid cooling apparatus can also be started up rapidly in a starting phase. The pump 272 can be switched on in a simple manner without a time delay.

A fuel cell block 14 can thus also be rapidly heated up in a starting phase in order to reach an optimal operating temperature, a full cooling function of the liquid cooling apparatus 202 being simultaneously ensured; in the starting phase, the liquid can be guided in the second path 254 (bypass path).

A rapid heating up to a first threshold temperature T₁ can be achieved followed by a gentle temperature transition to an operating mode, in which the temperature of the liquid is controlled. This control takes place by means of a combination of the temperature-controlled two-way valve 232 and the fans 222, which are individually speed-controlled. Furthermore, the fans or banks of fans can be switched on by the switching device 260 in a temperature-controlled manner.

The energy consumption of the liquid cooling apparatus 202 can be minimised as the electronic control members to control the liquid flow are unnecessary. Some of the fans 222 can be switched away by the switching device 260 if these are unnecessary (below the second threshold temperature T₂). Furthermore, the energy consumption can be minimised in that the pump 272 is operated in an operationally optimised manner to a constant working point.

The liquid cooling apparatus 202 is operated autonomously; the mass flow control by the two-way valve 232 and the fan control are based on internal measurements at the liquid cooling apparatus 202. The latter can react independently to changes, for example of the thermal inlet power and ambient temperature.

By pre-selecting the control temperature of the two-way valve 232 and/or of the working point of the pump 272, the liquid cooling apparatus 202 can be adapted to different operating temperature levels of a fuel cell system.

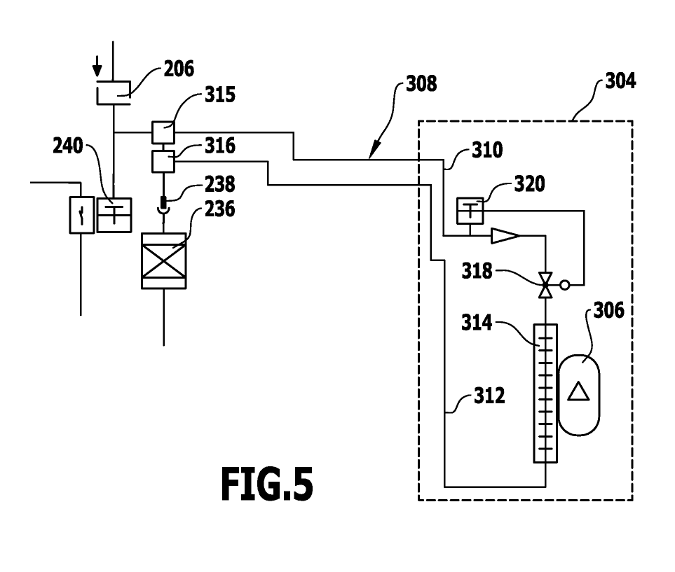

A further embodiment, which is shown schematically in a partial view in FIG. 5, has a connection possibility for a hydrogen storage module 304. The hydrogen storage module 304 in turn comprises a hydrogen sorption storage device 306. Hydrogen is stored in the hydrogen sorption storage device 306 by means, for example, of metal hydride sorption. Hydrogen is released by temperature-induced desorption, in particular.

For this purpose, a circuit 308 for liquid is provided. This circuit 308 in this case comprises a first branch 310, which is connected upstream of the hydrogen sorption storage device 306, and a second branch 312, which is connected downstream of the hydrogen sorption storage device 306. Arranged between the first branch 310 and the second branch 312 is a heat transfer device 314, by means of which the heat from heated liquid can be transferred to the hydrogen sorption storage device 306 for the desorption of hydrogen.

The first branch 310 is directly connected in a fluid-active manner to the inlet connection 206. Provided at the inlet connection 206 is heated liquid, which can then be supplied by the first branch 310 to the heat transfer device 314.

The second branch 312 opens into the filter device 236 before the plug-in coupling 238. A division device 315 and mixing device 316 are arranged, in this case, between the first branch 310 and the second branch 312. The flow of heated liquid picked up at the inlet connection 206 is divided by the distribution device into a first partial flow and a second partial flow. The first partial flow is introduced in the first branch 310 into the circuit 308. The second partial flow is supplied to the mixing device 316. The liquid flow which has passed through the circuit 308 is also introduced in the second branch 312 into the mixing device 316. This mixture is provided to the two-way valve 232 by means of the filter 236.

Only a partial flow of the total flow of heated liquid, which is provided by the inlet connection 206, flows through the circuit 308 and the mixture is cooled relative to the liquid at the inlet connection 206.

A switching valve 318, which is connected upstream of the heat transfer device 314, is arranged in the circuit 308. The switching valve 318 is realised, for example, by a control valve with an adjustable switching threshold. This switching valve 318 is temperature-controlled by an associated temperature sensor 320, which measures the temperature of the liquid in the first branch 310. Depending on a temperature switching threshold, the switching valve 318 is switched to pass or block; the temperature threshold in this case depends on the desorption temperature of hydrogen in the hydrogen sorption storage device 306. If the temperature of the liquid in the first branch 310 is too low, the switching valve 318 is switched to block in order to not bring about any cooling of the hydrogen sorption storage device 306 caused by the liquid cooling apparatus. (This could make the hydrogen desorption more difficult.)

Heated liquid, which is introduced by means of the inlet connection 206, is introduced into the first branch 310 in a partial flow. If this liquid has a temperature above the temperature threshold mentioned, the switching valve 318 is switched to through-flow. This heated liquid flows through the heat transfer device 314 and the latter is in thermal contact with the hydrogen sorption storage device 306.

It is possible here for the heat transfer device 314 to be integrated into the hydrogen sorption storage device 306 and, for example, to be arranged within a corresponding storage container.

The hydrogen sorption storage device 306 is heated by the heated liquid in order to ensure a desorption of hydrogen.

The liquid thus cooled is introduced by means of the second branch 312 into the mixing device 316 and mixed there with another partial flow of the liquid introduced by means of the inlet connection 206 and supplied to the two-way valve 232 by means of the filter 236.

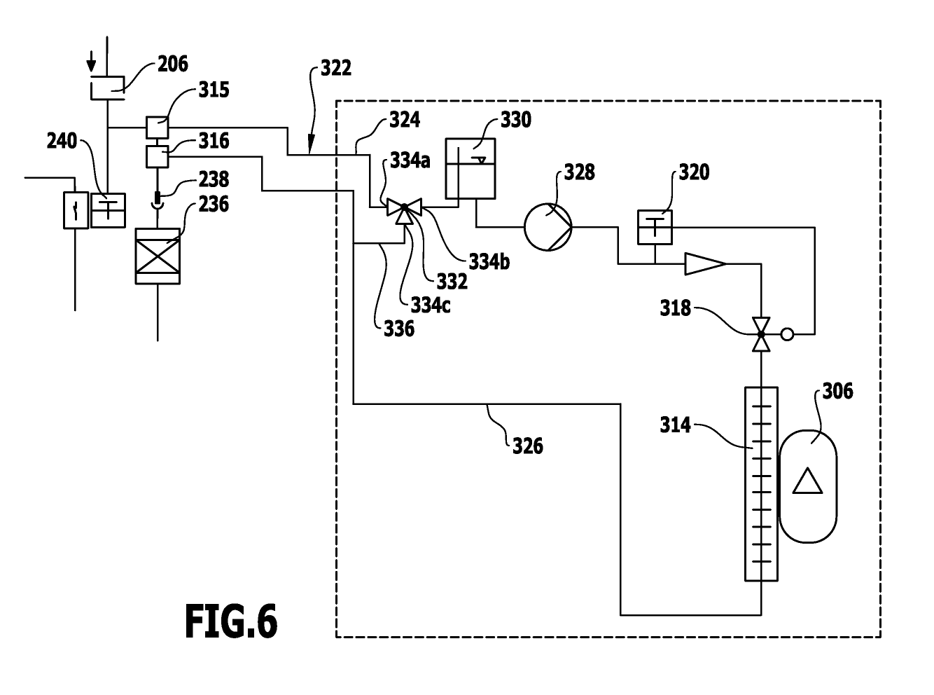

In a further embodiment, which is shown schematically in FIG. 6, a circuit 322 with a first branch 324 and a second branch 326 is provided. The same reference numerals are used here for the same elements as in the embodiment according to FIG. 5. Arranged between the first branch 324 and the second branch 326 is in turn the heat transfer device 314. The first branch 324 issues from a distribution device 315 and the second branch 326 opens into the mixing device 316.

A pump 328 is arranged in the first branch 324. In particular, this pump is driven by electric energy provided by the fuel cell system.

Connected downstream of the pump is a switching valve corresponding to the switching valve 318 with the associated temperature sensor 320.

Connected upstream of the pump 328 is a liquid container 330, which provides a liquid reservoir by means of the pump 328. This avoids cavitation occurring at the pump 328.

Arranged upstream of the liquid container 330 in the first branch is a flow adjustment device 332. Owing to the latter, the liquid flow to flow through the second circuit 322 can be adjusted.

In an embodiment, the flow adjustment device 332 comprises an inlet 334a, a first outlet 334b, which has a fluid-active connection with the liquid container 330, and a second outlet 334c.

The inlet 334a has a direct fluid-active connection with an outlet of the division device 315. From the second outlet 334c, a line 336 opens into the second branch 326. This allows the adjustment of a first partial flow to the pump 328 and a second partial flow, which is introduced directly into the second branch 326. The ratio of these partial flows determines the mass flow, which flows through the heat transfer device 314.

Otherwise, the liquid cooling apparatus functions as described above.

That which is claimed:

1. Liquid cooling apparatus for a fuel cell device, which is configured as an independent unit and which is adapted to provide the fuel cell device with cooling liquid and to remove heated liquid from the fuel cell device, comprising:
an inlet connection for liquid;
an outlet connection for liquid;
a radiator;
at least one fan, which is speed-controlled and directed at the radiator;
and
a temperature-controlled two-way valve;
wherein a first path passes through the radiator and a second path by-passes the radiator and a mass flow distribution of the liquid into the first path and the second path is adjustable by the two-way valve.

2. Liquid cooling apparatus according to claim 1, wherein the two-way valve is configured as a three/two-way valve.

3. Liquid cooling apparatus according to claim 1, wherein at least one temperature sensor is associated with the two-way valve, and wherein the two-way valve is controlled on the basis of measured temperature values of the at least one temperature sensor.

4. Liquid cooling apparatus according to claim 3, wherein the two-way valve has a detecting element, on which the at least one temperature sensor is arranged.

5. Liquid cooling apparatus according to claim 3, wherein the at least one temperature sensor is associated with a liquid reservoir.

6. Liquid cooling apparatus according to claim 3, wherein the at least one temperature sensor is arranged in such a way that an inlet temperature into a liquid reservoir is measurable or the at least one temperature sensor is arranged in such a way that a temperature in the liquid reservoir is measurable.

7. Liquid cooling apparatus according to claim 3, wherein the at least one temperature sensor is arranged in such a way that an outlet temperature following a pump is measurable.

8. Liquid cooling apparatus according to claim 1, wherein the two-way valve is configured as at least one of a thermostat valve and a thermo-hydraulic valve.

9. Liquid cooling apparatus according to claim 1, wherein said liquid cooling apparatus comprises a pump for conveying liquid, which is operated in an uncontrolled manner at a mass flow working point.

10. Liquid cooling apparatus according to claim 1, wherein said liquid cooling apparatus comprises an internal liquid reservoir.

11. Liquid cooling apparatus according to claim 1, wherein said liquid cooling apparatus comprises a filter device which is arranged downstream of the inlet connection.

12. Liquid cooling apparatus according to claim 1, wherein associated with the at least one fan is its own temperature sensor.

13. Liquid cooling apparatus according to claim 1, wherein associated with the at least one fan is its own speed controller.

14. Liquid cooling apparatus according to claim 1, wherein said liquid cooling apparatus comprises a plurality of fans, which are individually speed-controlled.

15. Liquid cooling apparatus according to claim 14, wherein said liquid cooling apparatus comprises a switching device, by means of which one or more fans are switchable on or off.

16. Liquid cooling apparatus according to claim 15, wherein a fan, when switched on, is operated at a finite minimum rotational speed.

17. Liquid cooling apparatus according to claim 15, wherein said liquid cooling apparatus comprises a temperature sensor, which measures the temperature of the liquid in the first path before entering the radiator, and wherein a fan is switchable on or off on the basis of the measured temperature values.

18. Liquid cooling apparatus according to claim 1, wherein said liquid cooling apparatus comprises an operating mode below a first threshold temperature for the liquid to be cooled, in which the liquid is guided by the two-way valve into the second path.

19. Liquid cooling apparatus according to claim 18, wherein, in this operating mode, at least one fan is operated at a finite minimum rotational speed.

20. Liquid cooling apparatus according to claim 18, wherein said liquid cooling apparatus comprises an opening of the two-way valve with temperature-controlled distribution of the mass flow of liquid into the first path and the second path when the first threshold temperature is exceeded.

21. Liquid cooling apparatus according to claim 20, wherein a speed control for the at least one fan is provided when the first threshold temperature is exceeded.

22. Liquid cooling apparatus according to claim 18, wherein a switching on of at least one further fan is provided when a second threshold temperature is exceeded, which is above the first threshold temperature.

23. Liquid cooling apparatus according to claim 22, wherein the switching on of the at least one fan takes place at a finite minimum rotational speed.

24. Liquid cooling apparatus according to claim 1, wherein, during operation, at least one fan is operated at least at a minimum rotational speed.

25. Liquid cooling apparatus according to claim 1, wherein said liquid cooling apparatus comprises an alarm device for monitoring operation.

26. Liquid cooling apparatus according to claim 25, wherein the alarm device comprises a plurality of limit monitors connected one behind the other.

27. Liquid cooling apparatus according to claim 25, wherein the alarm device comprises at least one of (i) a temperature monitor for an inlet temperature of the liquid; and (ii) a filling level monitor on a liquid reservoir; and (iii) a minimal through-flow monitor for liquid.

28. Liquid cooling apparatus according to claim 1, wherein a respective liquid coupling which blocks both ways is arranged at at least one of the inlet connection and the outlet connection.

29. Liquid cooling apparatus according to claim 1, wherein said apparatus has an autonomous configuration, a temperature control for the cooling being based on internal measurements.

30. Liquid cooling apparatus according to claim 1, wherein said liquid cooling apparatus comprises a circuit, in which heated liquid is provided to a hydrogen sorption storage device for the desorption of hydrogen.

31. Liquid cooling apparatus according to claim 30, wherein a heat transfer device, which is in thermal contact with the hydrogen sorption storage device, is arranged in the circuit.

32. Liquid cooling apparatus according to claim 30, wherein the circuit is connected downstream of the inlet connection for liquid.

33. Liquid cooling apparatus according to claim 30, wherein a switching valve for liquid to flow through a heat transfer device is arranged in the circuit and is temperature-controlled.

34. Liquid cooling apparatus according to claim 30, wherein said liquid cooling apparatus comprises a mixing device, by which a flow of heated liquid, which is provided by the inlet connection, and a flow from the hydrogen sorption storage device can be mixed and the mixture can be provided to the two-way valve.

35. Liquid cooling apparatus according to claim 30, wherein said liquid cooling apparatus comprises a distribution device, by which a liquid flow, which is provided by the inlet connection, is dividable into a partial flow for the circuit and a further partial flow.

36. Liquid cooling apparatus according to claim 30, wherein a pump is arranged in the circuit.

37. Liquid cooling apparatus according to claim 36, wherein a liquid container is connected upstream of the pump.

38. Liquid cooling apparatus according to claim 30, wherein a flow adjustment device is arranged in the circuit.

39. Fuel cell system, which comprises a fuel cell device and a liquid cooling apparatus for a fuel cell device, which is configured as an independent unit and which is adapted to provide the fuel cell device with cooling liquid and to remove heated liquid from the fuel cell device, comprising:
an inlet connection for liquid;
an outlet connection for liquid;
a radiator;
at least one fan, which is speed-controlled and directed at the radiator; and
a temperature-controlled two-way valve;
wherein a first path passes through the radiator and a second path by-passes the radiator and a mass flow distribution of the liquid into the first path and the second path is adjustable by the two-way valve; and
wherein the liquid cooling apparatus is coupled by an inlet connection and the outlet connection to the fuel cell device.
